(19) United States
(12) Patent Application Publication
(10) Pub. No.: US 2016/0260104 A1
(43) Pub. Date: Sep. 8, 2016

(54) METHODS AND SYSTEMS FOR THE ANALYSIS OF PATTERNS OF PURCHASE BEHAVIOR TO ESTIMATE THE MEMBERS OF A SPECIFIC ENTITY LOCATION

(71) Applicant: MasterCard International Incorporated, Purchase, NY (US)

(72) Inventors: Marianne IANNACE, North Salem, NY (US); Todd LOWENBERG, Redding, CT (US); Curtis VILLARS, Chatham, NJ (US); Serge BERNARD, Danbury, CT (US)

(73) Assignee: MasterCard International Incorporated, Purchase, NY (US)

(21) Appl. No.: 14/638,330

(22) Filed: Mar. 4, 2015

(51) Int. Cl. G06Q 30/02

(52) U.S. Cl. CPC G06Q 30/0201; G06Q 30/0205

(57) ABSTRACT

A method for identifying members based on purchase behavior analysis includes: storing a plurality of point of sale data entries, each including a point of sale identifier and a geographic location of the point of sale identifier; storing transaction data entries, each including data related to a payment transaction including at least a point of sale identifier, an industry type, a time and/or date, and a consumer identifier; receiving a data request related to a target geographic area; identifying at least one point of sale identifier associated with a geographic location located within the target geographic area; identifying at least one transaction data entry associated with the identified at least one point of sale identifier; classifying the at least one identified transaction data entry into at least one consumer transaction set; calculating a member estimation score for each consumer transaction set.

### FIELD

The present disclosure relates to the analysis of patterns of purchase behavior, specifically the analysis of such patterns to estimate membership for a specific entity.

### BACKGROUND

Advertisers, merchants, and other entities often seek to define a target market toward which they can direct advertisements, coupons, trial offers, or other messages. By defining such a market these entities may customize the message they wish to send to individual consumers, businesses, or other desired marketing targets. In some instances, an entity, such as an advertiser or merchant, may wish to target members of a particular entity location. For instance, a new gym may be relocating to a location near an office building and wish to target individuals who may be associated with the office building and who might likely want to become members of the new gym. The new gym could distribute flyers around the new location, advertising the services of the gym. But, some people may not be interested in using such services and others that are might not see or ignore the flyers or the like, or not be regularly in the area because they are not associated with the office building (e.g., employed by or be a tenant). Thus, the advertisements distributed this way do not result in increased revenue for the new gym; rather, the advertisements wasted on non-gym-interested local people represent a loss for the new gym. Further, the business or other entity may not be willing to cooperate in identifying people regularly at the entity for a variety of reasons. Surveys and other mechanisms for having people self-identify their association with an entity location are costly in terms of labor intensity and computer resources, in that a large population of possible or candidate local people would have to be asked and there answers analyzed, as might be done on a large geography basis that then can be sorted based on self-identified, unconfirmed or verified location relationships.

On a different note, one manner in which advertisers and the like identify a target market includes gathering consumer data. In some instances, the gathering of consumer data includes transaction data associated with payment transactions involving a consumer. Such information can be useful for identifying a particular consumer's purchasing behavior and targeting messages to such a consumer based upon that behavior. But, targeted consumers are often worried about the distribution of their personal information to advertisers and other entities.

Accordingly, there is a perceived need to identify members of a particular entity location in an automated fashion using less and more accurate computer processes with a degree of precision significantly greater than that of a random messaging campaign to individuals within a predetermined proximity of a location. Further, there is also a need to isolate members of a particular entity location anonymously, thereby protecting personal information of the isolated members.

### SUMMARY

The present disclosure provides a description of systems and methods for identifying members of a specific entity location based upon purchasing pattern analysis, that, depending on implementation, can fulfill these and other needs by providing a technical solution to the technical problems identified above.

A method for identifying entity members based on purchase behavior analysis includes: storing, in a geographic location database, a plurality of point of sale data entries, wherein each point of sale data entry includes at least a point of sale identifier and a geographic location of the point of sale identifier; storing, in a transaction database, transaction data entries for a plurality of payment transactions, wherein each transaction data entry includes data related to a payment transaction including at least a point of sale identifier, an industry type, a time and/or date, and a consumer identifier; receiving, by a receiving device, a data request, wherein the data request includes a target geographic area for which transaction data is requested; identifying, by a processing device, at least one point of sale identifier associated with a geographic location located within the target geographic area; classifying, by the processing device, the at least one point of sale identifier into at least one consumer transaction set, wherein each consumer transaction set includes at least one transaction data entry and where all transaction data entries included in a single consumer transaction set include a common consumer identifier; and calculating, by the processing device, a member estimation score for each consumer transaction set, wherein the calculation is based on at least the data related to the payment transaction included in each transaction data entry of the consumer transaction set.

A system for identifying entity members based on purchase behavior analysis, includes: a geographic location database configured to store a plurality of point of sale data entries, wherein each point of sale data entry includes at least a point of sale identifier and a geographic location of the point of sale identifier; a transaction database configured to store transaction data entries for a plurality of payment transactions including at least a point of sale identifier, an industry type, a time and/or date, and a consumer identifier; a receiving device configured to receive a data request, wherein the data request includes a target geographic area for which transaction data is requested; and a processing device configured to: identify at least one point of sale identifier associated with a geographic location located within the target geographic area, identify at least one transaction data entry associated with the at least one point of sale identifier, classify the at least one identified transaction data entry associated with the at least one point of sale identifier into at least one consumer transaction set, wherein each consumer transaction set includes at least one transaction data entry and where all transaction data entries included in a single consumer transaction set include a common consumer identifier, and calculate a member estimation score for each consumer transaction set based on at least the data related to the payment transaction included in each transaction data entry of the consumer transaction set.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for identifying entity members based upon purchase pattern analysis in accordance with exemplary embodiments.

FIG. 2 is a block diagram illustrating a processing server for use in the system of FIG. 1 for the identification of entity members based upon the analysis of consumer purchasing behavior in accordance with exemplary embodiments.

FIG. 3 is an illustration of the transaction database of the system of FIG. 1 and the processing server of FIG. 2 in accordance with exemplary embodiments.

FIG. 4 is a flow chart illustrating a process for the identification of entity members based upon purchase pattern behavior carried out by the processing server of FIG. 1 in accordance with exemplary embodiments.

FIG. 5 is a flow chart illustrating an exemplary method for estimating members of a particular entity based upon consumer transaction data.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant or it may be data representing the associated payment account (e.g., data stored in a communication device, such as a smart phone or computer). In some instances, a payment card may be a number associated with a payment account, not tied to a physical card or device. A check may be considered a payment card, where applicable.

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems where the processing system 110 does not need to possess any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the processing system 110 may not possess the PII or be able to decrypt the encrypted PII.

### System for Estimating Members of a Specific Entity Location

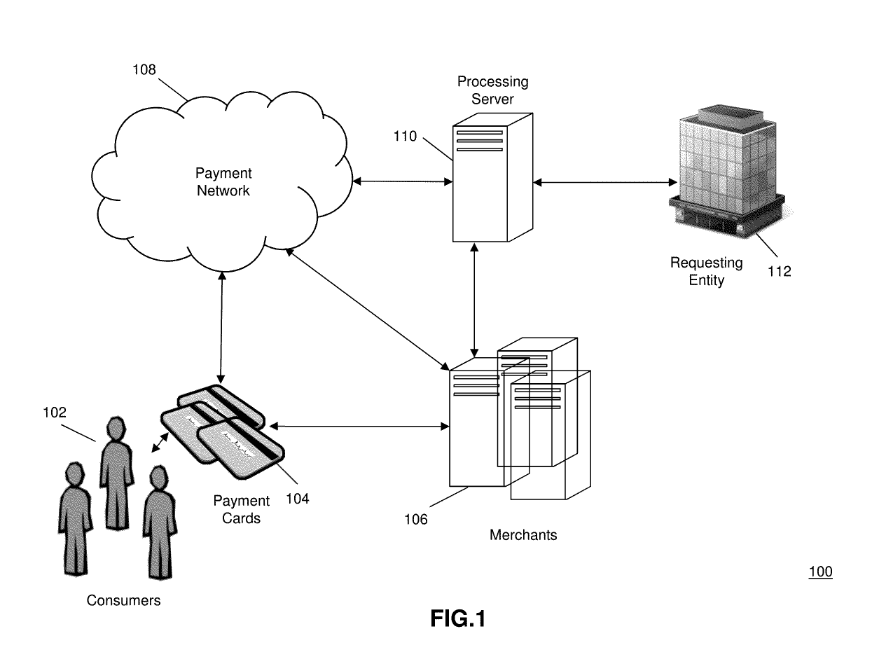

FIG. 1 illustrates an exemplary embodiment of a system 100 for estimating members of a specific entity location (e.g., people that seem associated with an entity location based on such things as the type of transaction, merchant codes, location of point of sales, demographic information and other information that tends to indicate if a person is regularly present at a given location perhaps through employment, membership in a club, or other reason to be drawn to a given entity location), based upon purchase behavior analysis. The components of system 100 may communicate with each other via a network. The network may be any network suitable for performing the functions discussed herein, including a local area network (LAN), a wide area network (WAN), a wireless network (e.g., WiFi), a mobile communication network, a satellite network, the Internet, fiber optic, coaxial cable, infrared radio frequency (RF), or any combination thereof. Other suitable network types and configurations will be apparent to persons having skill in the relevant art. The system 100 may include several consumers 102 each of which possess one or more consumer cards 104. The system may further include one or more merchants 106.

Exemplary Transaction Protocol

In an exemplary embodiment, a consumer 102 may conduct a transaction, or multiple transactions, with one or more merchants 106 funded by a payment card 104, which may be issued by an issuer (not pictured). The payment card 104 may be a credit card, debit card, hybrid card, merchant card, or any other form of payment card. The payment card may be a physical card that may be provided to a merchant 106 or it may be data representing the payment account (e.g., data stored in a communication device, such as a smart phone or a computer). In some instances, a payment card may be a number associated with a payment account, not tied to a physical card or device. The transaction between the consumer 102 and merchant 106 may be an in-person transaction (e.g., at the physical location of the merchant 106).

The merchant 106 may submit a transaction authorization request to the payment network 108 for the payment transaction funded by payment card 104. The merchant 106 may submit the authorization request directly to the payment network or via another entity, such as an acquirer (not pictured).

The payment network 108 may receive the transaction authorization request from the merchant 106, wherein the transaction authorization request is a request for approval of a transaction initiated by a consumer 102 and funded by the payment card card 104. The transaction authorization request may include the consumer card information (e.g., a payment account number or another identifier associated with the payment account) as well as transaction information (e.g., the transaction amount, time and/or date of the transaction, product or service information, merchant location information, merchant type information, etc.). The payment network 108 may process the authorization request. In some instances, the payment network 108 may transmit the authorization request to an issuer (not pictured) associated with the payment card 104 used to initiate the transaction. The payment network 108 may receive a transaction authorization response from the issuer (not pictured) approving or denying the transaction and then transmit (directly or indirectly) the authorization response to the merchant 106.

The payment network 108 may receive, transmit, and/or store transaction information for each financial transaction processed. The payment network 108 may receive, transmit, and/or store additional consumer information or merchant information. Other types of information that may be received, transmitted and/or stored by the payment network 108 will be apparent to those having relevant skill in the art.

Transaction Information Capture

The processing server 110 may receive transaction data from the payment network 108 and store the transaction information within a database. The processing server may be included within payment network 108 or may be a separate entity. The processing server 110 may receive additional information from the payment network 108, such as merchant data or consumer data. The information received by the processing server 110 from the payment network 108 may include data identifying a point of sale device and/or merchant identifier associated with the identified point of sale device and/or merchant. In some embodiments, the processing server 110 may receive information directly from a merchant 106, issuer (not pictured) or consumer 102.

The processing server 110 may further receive geographic location information associated with a point of sale device and/or a merchant 106 from the payment network 108. In some embodiments, the processing server 110 may receive information related to the geographic location associated with a point of sale device and/or merchant 106 from an entity other than the payment network 108. For instance, the processing server may retrieve geographic location data for merchants 106 from a publically accessible database. The processing server 110 may store information received relating to the geographic location and associated point of sale device identifier and/or associated merchant identifier in a database.

Identification of Members of an Entity Location

In some embodiments, the processing server 110 may receive a request for identifying entity members based on purchase behavior analysis from a requesting entity 112. The requesting entity 112 may be any entity that requests member estimation information. The requesting entity may request member estimation scores themselves or information for calculating member estimation scores. The requesting entity 112 may transmit a request for member estimation information to the processing server 110, which may include a request identifying a particular entity, or multiple entities, for which membership data is desired. In some embodiments, the request for member estimation information may include a physical address or other geographic identification data (e.g., latitude and longitude coordinates, an area within a radius surrounding a physical address, a city block, etc.) associated with an entity for which membership estimation is requested. In some embodiments, the request for member estimation information may include an identifier that does not directly identify the geographic location of an entity for which information is sought. In such embodiments, the processing server 110 may retrieve geographic location information for the entity associated with the membership estimation request from another source (e.g., an internal database, a publicly available data source, etc.)

In some embodiments, the requesting entity 112 may also be a merchant 106. The processing server 110 may receive the membership estimation request via a network, by manual input, or other manners for receiving data that will be apparent to those having skill in the relevant art.

Methods and systems discussed herein may be able to estimate membership information for an entity (or multiple entities) associated with a request for membership estimation.

### Processing Server

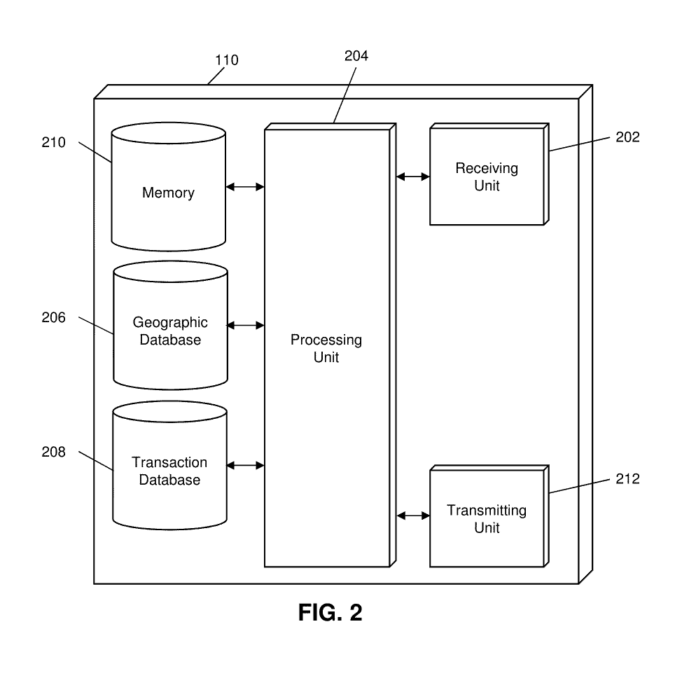

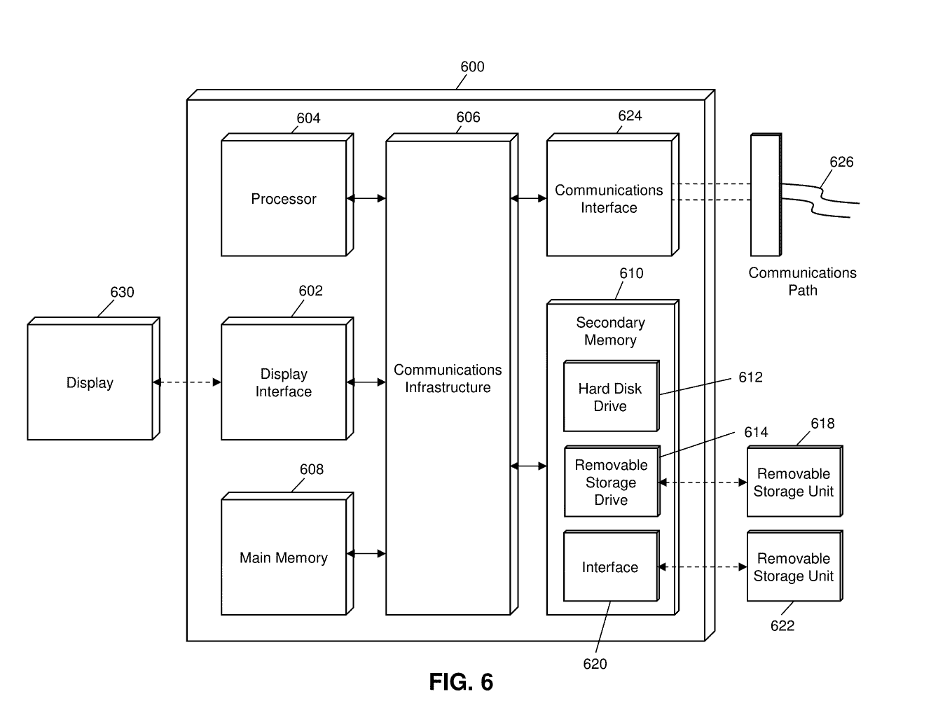

FIG. 2 illustrates an exemplary embodiment of the processing server 110 of the system 100. It will be apparent to persons having skill in the relevant art that the embodiment of the processing server 110 depicted in FIG. 2 is provided as an illustration only and may not be exhaustive as to all possible configurations of the processing server 110 suitable for performing the functions discussed herein. For example, the computer system 600 illustrated in FIG. 6 and discussed in more detail below may be a suitable configuration of the processing server 110.

The processing server 110 may include a receiving unit 202. The receiving unit 202 may be configured to receive data over one or more networks via one or more network protocols. The receiving unit 202 may receive merchant information, consumer information, and transaction information, from the payment network 108, or another entity associated with a payment network (e.g., a merchant 106, an issuer, an acquirer, etc.). The receiving unit 202 may receive additional information from the payment network 108, via a network other than the payment network 108, or by other means for receiving the type of data described herein that will be apparent to one having skill in the relevant art.

The processing server 110 may store received transaction, consumer, and/or merchant data within one or more databases. In some embodiments, the processing server 110 may include a geographic location database 206, in which a plurality of point of sale data entries may be stored. The point of sale data entries may include information received via the receiving unit 202 related to the geographic location of a point of sale device. In some embodiments, each point of sale data entry may include a single point of sale device identifier and the corresponding physical address of the single point of sale device. In some embodiments, each point of sale data entry may include multiple point of sale device identifiers, each associated with a single physical address. The physical address associated with one or multiple point of sale identifiers may be represented by a conventional street address (e.g., 123 main street) or may be defined in other terms, such as by geographic coordinates, building location, distance from a particular reference point, and other means capable of identifying a geographic location that will be apparent to persons having skill in the relevant art.

In some embodiments, the processing server 110 includes a transaction database 208, in which a plurality of transaction data entries for a plurality of payment transactions are stored. Each transaction data entry may include data related to a payment transaction, such as one or more of the following: a consumer identifier, a payment card identifier, a merchant identifier, a point of sale identifier, industry information related to a product or merchant type, particular product data (e.g. an item description, an item quantity, an item product code, etc.) related to goods or services being purchased, geographic location information related to the merchant and/or point of sale device, a time and/or date of transaction, a total transaction amount, information regarding a discount or coupon used in a transaction, consumer identification information, merchant identification information, etc.

The receiving unit 202 may receive a data request (directly or indirectly) from a requesting entity 112. The received data request may include data related to an entity for which membership information is sought. The received data request may be a request for the identification of members associated with the physical address of the entity. The received data request may include entity identification information associated with the entity for which membership data is sought. Entity identification information may include: a name of an entity, physical location information for an entity (e.g., a street address, a building name, latitude and longitude, etc.), or other information suitable for use in determining a target geographic area indicative of membership of an entity. In some embodiments, the data request includes a predetermined target geographic area (e.g., a physical address, an area surrounding a physical address, a city block, a neighborhood, etc.). In some embodiments, the receiving unit 202 receives a data request from a requesting entity 112 and the processing server 110 accesses information identifying the physical location of the entity for which membership estimation is requested separately from the received data request. In some embodiments, the receiving unit may receive a single request for membership information for each of a plurality of entities within a predetermined area.

The received data request may include information in addition to the entity identification information. In some embodiments, the request may include data requesting the identification of one or multiple types of members of an entity for which data is requested. For instance, the request may specify that information is requested for “new members” of a particular gym or “university students” of a particular college campus. In some embodiments, the request may specify other criteria that the processing server 110 may take into account in the methods for identifying entity members described herein.

The processing server may include a processing unit 204. The processing unit 204 may be configured to process the data request received from a requesting entity 112 and identify a target geographic area associated with the data request. In some embodiments, the data request may include a specified target geographic area. In some embodiments, the processing unit 204 may determine a target geographic area based upon the received data request and/or additional information indicative of membership in an entity. For instance, the data request may include an entity name for which membership information is requested and the processing unit 204 may associate the entity name with a geographic location of the entity. The processing unit 204 may identify a target geographic area based upon the geographic location of the entity. In some embodiments, the target geographic area may include only the geographic location of the entity itself. In some embodiments, the target geographic area may include an area surrounding the geographic location of the entity, instead of, or in addition to, the geographic location of the entity itself.

The processing unit 204 may identify, in the geographic location database 206, at least one point of sale identifier associated with a geographic location located within the target geographic area. The processing unit 204 may further identify, in the transaction database 208, at least one transaction data entry associated with the identified at least one point of sale identifier. The processing unit 204 may identify all transaction data entries associated with the at least one point of sale identifier or may identify transaction data entries based upon additional factors associated with the transaction data entries. In some embodiments, the processing unit 204 may identify all transaction data entries associated with a point of sale device located within the target geographic area. In some embodiments, the processing unit 204 may identify only those transaction data entries associated with a point of sale device located within the target geographic area that satisfy additional criteria (e.g., that satisfy a specified time period, type of transaction, etc.). For example, the processing unit 204 may identify all transactions conducted at a particular point of sale device during a specified amount of time (e.g., in the past week) or all transactions conducted recently (e.g., within the past week, month, year, etc.) that occurred between the hours of 11 a.m. and 2 pm. on weekdays. In an exemplary embodiment, the processing unit 204 may identify a plurality of transaction data entries, each associated with one of several point of sale identifiers.

The processing unit 204 may be configured to classify the one or more transaction data entries associated with the one or more point of sale identifiers into at least one consumer transaction set. Each consumer set may include at least one transaction data entry associated with a unique consumer identifier. Where multiple transaction data entries are classified into a single transaction set, each data entry in the transaction set may be associated with the same consumer (e.g., each may include a common consumer identifier).

The processing unit 204 may be further configured to calculate a member estimation score for each consumer transaction set. The calculated member estimation score may be based upon data related to each of the transaction data entries within a consumer transaction set. In some embodiments, multiple member estimation scores may be calculated for a single consumer transaction set, wherein each member estimation score is associated with a particular member type. For example, a first member estimation score may indicate the likelihood that a consumer associated with a consumer transaction set is a new employee of a particular entity, and a second member estimation score may indicate the likelihood that the consumer is a tenured employee of the entity.

The member estimation score may be calculated by assigning weights to various data values or patterns of the transaction data entries within a consumer transaction set. In some embodiments, the weighted calculation may depend upon transaction data entries or a pattern of transaction data entries associated with particular types of industries (e.g., key industry categories determined to be indicative of an employee's action at work). In some embodiments, transactions associated with some point of sale devices within a target area may be weighted more heavily than other point of sale devices within the target area. For instance, transactions that take place at a point of sale device physically located at an entity location are weighted more heavily (i.e., they are indicative of a higher likelihood that the consumer is a member of the entity) than transactions associated with point of sale identifiers located at a distance from the entity location. In some embodiments, the member estimation score may depend on the recency or frequency of transactions associated with the consumer transaction set. The member estimation score for a consumer transaction set may be based upon a calculation that takes into account one or more of: a recency or frequency of transactions within the consumer transaction set, a proximity of point of sale devices to an entity location, an industry type, a merchant type, a product/service type, transactions occurring within a particular time period (e.g., a particular day, week, year; the most recent day, week, year; etc.), the time and/or day, the transaction amount, etc. Additional factors the member estimation score may take into account will be apparent to those having relevant skill in the art.

In some embodiments, the processing unit 204 may be further configured to classify the member estimation score associated with a consumer identifier of a consumer transaction set into one of a plurality of member confidence tiers. In some embodiments the confidence tiers represent a population of members having a specific probability (or range of probabilities) of being a member of the entity for which membership information is requested. In some embodiments, the member confidence tiers may be indicative of consumers having a high likelihood of not being associated with the entity for which membership information is requested. In some embodiments, multiple member confidence tiers may be provided for multiple member types (e.g., confidence tiers indicating the likelihood a consumer is a member of a gym; confidence tiers indicating the likelihood a consumer is an employee of a gym etc.).

The processing server 110 may include memory 210. The memory 210 may be configured to store data suitable for performing the functions of the processing server 110 discussed herein. For example, the memory 210 may be configured to store weighting factors and/or algorithms for the calculation of member estimation scores and/or transaction data, merchant data, consumer data, and/or geographic location data (e.g., of a point of sale device, a physical entity address, etc.). Additional data that may be stored in the memory 208 will be apparent to persons having skill in the relevant art.

The processing server 110 may further include a transmitting unit 212. In some embodiments the transmitting unit 212 may be configured to transmit one or more calculated member estimation scores for each consumer transaction set to an entity, such as the requesting entity 112. In some embodiments, the transmitting unit 212 may be configured to transmit information related to consumer identifiers classified within one or more member confidence tiers.

The processing server may also include the memory 208. The memory 208 may be configured to store data suitable for performing the functions of the processing server 110 discussed herein. For example, the memory 208 may be configured to store weighting factor and/or algorithms for the calculation of member estimation scores and/or transaction data, merchant data, consumer data, and/or geographic location data (e.g., of a point of sale device, a physical entity address, etc.). Additional data that may be stored in the memory 208 will be apparent to persons having skill in the relevant art.

It will be apparent to persons having skill in the relevant art that the processing server 110 may include additional and/or alternative components to those illustrated in FIG. 2 and discussed herein, and that the components illustrated in FIG. 2 may be further configured to perform additional functions.

### Transaction Database

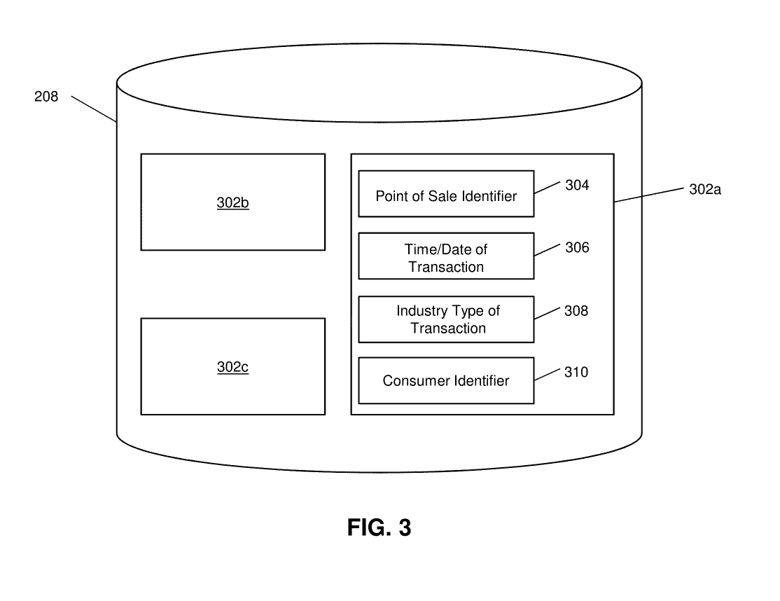

FIG. 3 illustrates a possible embodiment of the transaction database 208 of the processing server 110. The transaction database 208 may include a plurality of transaction data entries 302, illustrated as transaction data entries 302a, 302b, and 302c. Each transaction data entry 302 may represent a single transaction. Each transaction data entry 302 may include at least a point of sale identifier 304, a time and date of the transaction 306, an industry type of transaction 308, and a consumer identifier 310. In some embodiments, the transaction data entries may include additional transaction data, consistent with transaction data described herein. Additional types of transaction data that may be included in transaction data entries 302 will be apparent to those having skill in the relevant art, and may include any types of transaction data discussed herein.

In some embodiments, the point of sale identifier 304 may be a unique value associated with a single point of sale device. In some embodiments, the point of sale identifier 304 may be a value associated with all point of sale devices located at a same physical location. In some embodiments, the point of sale identifier 304 may be data useful for identifying a point of sale location (e.g., merchant name, address, telephone number, etc.). The transaction data entry may additionally include data related to a time and date of the transaction 306. The industry type of transaction 308 may be based upon or include data related to particular merchants, merchant types, products or goods purchased, types of products or goods purchased, etc.

The consumer identifier 310 may be a unique value associated with a consumer (e.g., a consumer 102) for identification of the consumer. In some embodiments, the consumer identifier 310 may be an account number, such as for a payment card account. In some embodiments, the consumer identifier 310 may be data associated with a payment card account, other than an account number (e.g., an e-mail address, a telephone number, a name, etc.). In some embodiments, the transaction information received and stored in the transaction database 302 may not include any personally identifiable information (PII). In one such an embodiment, the consumer identifier 310 may be a unique value based upon an anonymized cardholder identifier.

In some embodiments, the transmitting device 212 may transmit a consumer identifier 310 or multiple consumer identifiers 310 (e.g., such as all consumer identifiers classified within a particular member confidence tier) associated with a member estimation score to an external source capable of providing consumer data. The external source may associate the unique consumer identifiers with consumer data useful for messaging a targeted consumer, such as a name, address, e-mail address, telephone number, cookie (i.e., PII data), etc. The consumer data may be transmitted by the external source to the processing server 110 or to another entity, such as the requesting entity 112. The consumer data may provide a target audience including the same consumers associated with the transaction data entries or a target audience including consumers having very similar characteristics to those associated with the transaction data entries (e.g., a similar member estimation score or having similar consumer behavior patterns).

### Identification of Target Audience Based Upon Member Estimation

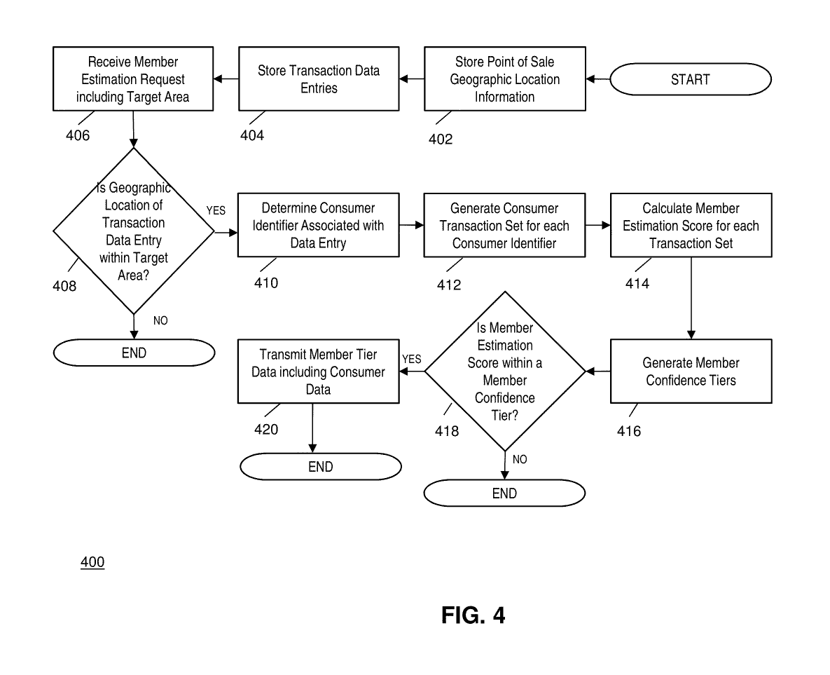

FIG. 4 illustrates an exemplary process 400, using the processing server 110 of FIG. 1, for the identification of a target audience based upon member estimation methods discussed herein.

In step 402, point of sale information may be stored in a geographic location database (e.g., the geographic location database 206). The point of sale information stored in the geographic location database may include a point of sale identifier and geographic location information associated with the physical location of the point of sale. In step 404, transaction data (e.g., transaction data received from the merchants 106) may be stored in a transaction database (e.g., the transaction database 208). Each transaction data entry may include data related to a transaction conducted at one of a plurality of merchants. Transaction data that may be stored within the transaction database includes all transaction data discussed herein and additional transaction data that would be apparent to one having skill in the relevant art.

In step 406, the processing server 110 may receive a member estimation request. The member estimation request of step 406 may include a specified target area (e.g., the physical business location of the entity for which membership is requested). In step 408, the processing server 110 may determine whether any transaction data entries include a point of sale identifier having a geographic location within the target area.

In step 410, if one or more transaction data entries include a point of sale identifier corresponding to the target area, the processing server 110 may determine the consumer identifier associated with the transaction data entries. In step 412, the processing server 110 may generate a consumer transaction set including all transactions associated with a single consumer. In step 414, a member estimation score may be calculated for each consumer transaction set associated with a unique consumer (i.e., a member estimation score may be determined for each unique consumer identifier based on the spending patterns of the consumer associated with the consumer identifier).

In step 416, member confidence tiers may be generated, wherein each member confidence tier corresponds to a particular member confidence score or range of member confidence scores.

In step 418, the processing server 110 may determine whether to classify each consumer into a member confidence tier (i.e., the processing server 110 may determine whether one of the plurality of member confidence tiers corresponds to the member estimation score.

In step 420, the processing server 110 may transmit member tier data including consumer data for one or multiple member confidence tiers to a requesting entity or some other entity, as discussed herein.

For example, in an exemplary embodiment, the member estimation request may be for identifying new employees of a particular company. The company may have a large campus, including one building where all new employees are trained. The member estimation request may include physical location information related to the training building. Alternatively, the physical location information may be determined by other means discussed herein and those that will be apparent to persons having skill in the relevant art. The physical location information may be an address of the training building (e.g., 123 Main St.). The processing server may identify one or multiple point of sales (e.g., merchants, devices, etc.) that are located at 123 Main St. For instance, the processing server may identify a point of sale corresponding to the convenience shop located in the lobby of the training building. In other exemplary embodiments, multiple points of sales may be identified that are located at a particular address (e.g., both a coffee shop and a convenience store may be located within a particular building). In other exemplary embodiments, the target area (received or determined) may be an area including the training building and some of the surrounding buildings.

In the example provided, the training building may share an address with a single point of sale (e.g., the convenience shop). The processing server may determine all consumer identifiers associated with the point of sale identifier corresponding to the training building's convenience shop. The processing server classify the transaction data into consumer transaction data sets. For example, Consumer Transaction Set A may include all transactions made by Consumer A (and only transactions made by Consumer A) at the convenience shop. Consumer Transaction Set B may include all transactions made by Consumer B (and only transactions made by Consumer B) at the convenience shop.

The processing server may determine a member estimation score for Consumer A, based upon a weighted calculation that takes into account some or all of the transaction data within each transaction entry of Consumer Transaction Set A. The processing server may identify member confidence tiers into which consumers having a particular member estimation score can be classified. For instance, a first member confidence tier may correlate to member estimation scores that indicate a high probability of membership. The processing server may classify Consumer A into the first membership confidence tier with members having a similar membership estimation score as Consumer A. The member tier data including Consumer A and similar consumers may be transmitted to a requesting entity for the identification of a target audience.

### Exemplary Method for Identification of Entity Members

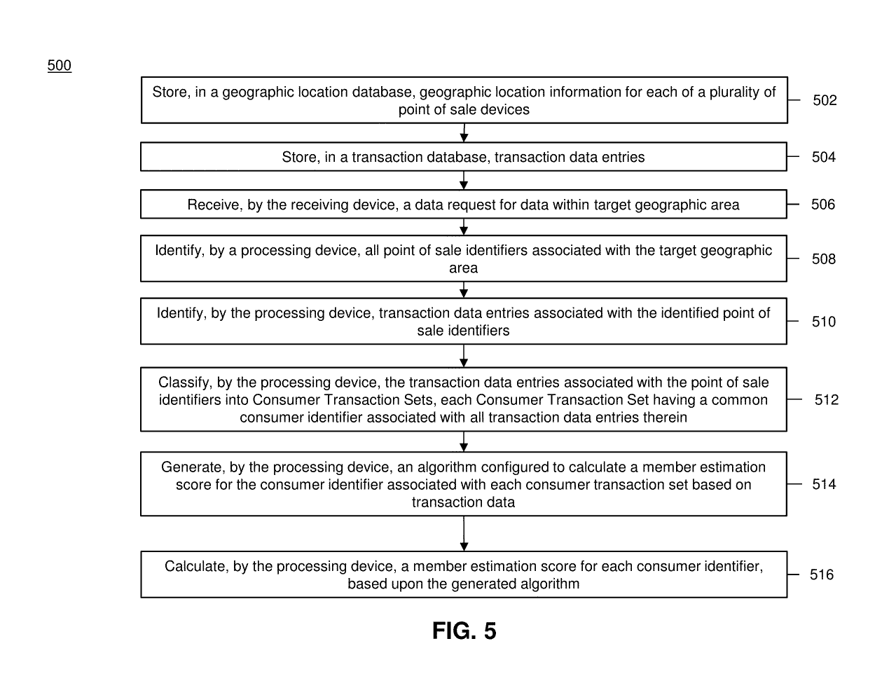

FIG. 5 illustrates an exemplary method 500 for identifying members of a particular entity for which membership information is requested. In step 502, geographic location information is stored in a database for each of a plurality of point of sale devices. In step 504, transaction data entries are stored for a plurality of transactions, wherein each transaction data entry includes at least a point of sale identifier.

In step 506, a request for member identification data is received by a receiving device (e.g., receiving device 202) from a requesting entity. The request may include target area data or may include information from which a processing device can determine a target geographic area. In step 508, a processing device may identify all point of sale identifiers associated with (e.g., located within, located around, etc.) the target geographic area.

In step 510, the processing device may identify all transaction data entries associated with the point of sale identifiers corresponding to the target geographic area. In step 512, the processing device may summarize all transaction data entries associated with a unique consumer identifier into consumer transaction sets, wherein each transaction data entry within a single consumer transaction set includes the same consumer identifier as every other transaction data entry in the single consumer transaction set.

In step 514, the processing device may generate an algorithm configured to calculate a member estimation score for the consumer identifier associated with each consumer transaction set. In step 516, the processing device may calculate a member estimation score for each consumer transaction set based upon the generated algorithm. The member estimation score for a single consumer transaction set may be considered a member estimation score for a unique consumer.

### Computer System Architecture

FIG. 6 illustrates a computer system 600 in which embodiments of the present disclosure, or portions thereof, may be implemented as computer-readable code. For example, the processing server 110 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIG. 4 and FIG. 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in the hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be descried as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radiofrequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 700 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600 including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.) These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed may enable processor device 604 to implement the methods illustrated by FIG. 4 and FIG. 5 as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for maintaining consumer privacy in behavioral scoring. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying entity members based on purchase behavior analysis, comprising:
storing, in a geographic location database, a plurality of point of sale data entries, wherein each point of sale data entry includes at least a point of sale identifier and a geographic location of the point of sale identifier;
storing, in a transaction database, transaction data entries for a plurality of payment transactions, wherein each transaction data entry includes data related to a payment transaction including at least a point of sale identifier, an industry type, a time and/or date, and a consumer identifier;
receiving, by a receiving device, a data request, wherein the data request includes information related to a target geographic area for which transaction data is requested;
identifying, by a processing device, at least one point of sale identifier associated with a geographic location located within the target geographic area;
identifying, by the processing device, at least one transaction data entry associated with the identified at least one point of sale identifier;
classifying, by the processing device, the at least one identified transaction data entry associated with the at least one point of sale identifier into at least one consumer transaction set, wherein each consumer transaction set includes at least one transaction data entry and where all transaction data entries included in a single consumer transaction set include a common consumer identifier;
calculating, by the processing device, a member estimation score for each consumer transaction set, wherein the calculation is based on at least the data related to the payment transaction included in each transaction data entry of the consumer transaction set.

2. The method of claim 1, further comprising:
transmitting, by a transmitting device, at least the calculated member estimation score for each consumer transaction set and the common consumer identifier.

3. The method of claim 1 further comprising:
classifying, by the processing device, each consumer transaction set into one of a plurality of member confidence tiers, wherein each member confidence tier is associated with a predetermined range of member estimation scores; and
transmitting, by a transmitting device, member confidence tier data related to at least one member confidence tier of the plurality of member confidence tiers and the common consumer identifiers associated with each consumer transaction set classified within the at least one member confidence tier.

4. The method of claim 1, wherein the consumer identifier included in each transaction data entry is an encrypted consumer identifier.

5. The method of claim 4, further comprising:
receiving, by the receiving device, a set of consumer characteristics corresponding to the common consumer identifier associated with each of the consumer transaction sets; and
transmitting, by a transmitting device, at least the calculated member estimation score for each consumer transaction set and the set of consumer characteristics corresponding to the common consumer identifier associated with each consumer transaction set.

6. The method of claim 1, wherein the target geographic area corresponds to a physical postal address of a business entity.

7. The method of claim 1, wherein the target geographic area corresponds to an area immediately surrounding a physical postal address of a business entity.

8. The method of claim 7, wherein calculating a member estimation score includes assigning a weighted value to each transaction data entry of the consumer transaction set based on the geographic location of the point of sale identifier associated with each transaction data entry and the proximity of the geographic location of the point of sale identifier to the physical postal address of the business entity.

9. The method of claim 1, wherein calculating a member estimation score for each consumer transaction set takes into account at least one of: a frequency of payment transactions associated with the transaction data entries of the consumer transaction set, a recency of payment transactions associated with the transaction data entries of the consumer transaction set and an industry type of payment transaction associated with the transaction data entries of the consumer transaction set.

10. The method of claim 8, wherein calculating a member estimation score for each consumer transaction set takes into account at least one of: a frequency of payment transactions associated with the transaction data entries of the consumer transaction set, a recency of payment transactions associated with the transaction data entries of the consumer transaction set and an industry type of payment transaction associated with the transaction data entries of the consumer transaction set.

11. A system for identifying entity members based on purchase behavior analysis, comprising:
a geographic location database configured to store a plurality of point of sale data entries, wherein each point of sale data entry includes at least a point of sale identifier and a geographic location of the point of sale identifier;
a transaction database configured to store transaction data entries for a plurality of payment transactions, wherein each transaction data entry includes data related to a payment transaction including at least a point of sale identifier, an industry type, a time and/or date, and a consumer identifier;
a receiving device configured to receive a data request, wherein the data request includes information related to a target geographic area for which transaction data is requested; and
a processing device configured to:
identify at least one point of sale identifier associated with a geographic location located within the target geographic area,
identify at least one transaction data entry associated with the identified at least one point of sale identifier,
classify the at least one identified transaction data entry associated with the at least one point of sale identifier into at least one consumer transaction set, wherein each consumer transaction set includes at least one transaction data entry and where all transaction data entries included in a single consumer transaction set include a common consumer identifier, and
calculate a member estimation score for each consumer transaction set based on at least the data related to the payment transaction included in each transaction data entry of the consumer transaction set.

12. The system of claim 11, further comprising:
a transmitting device configured to transmit at least the calculated member estimation score for each consumer transaction set and the common consumer identifier associated with each consumer transaction set.

13. The system of claim 11, wherein the processor is further configured to:
classify each consumer transaction set into one of a plurality of member confidence tiers, wherein each member confidence tier is associated with a predetermined range of member estimation scores, and
transmit member confidence tier data related to at least one member confidence tier of the plurality of member confidence tiers and the common consumer identifier associated with each consumer transaction set classified within the at least one member confidence tier.

14. The system of claim 11, wherein the consumer identifier included in each transaction data entry is an encrypted consumer identifier.

15. The system of claim 14, wherein the receiving device is further configured to receive a set of consumer characteristics corresponding to the common consumer identifier associated with each of the consumer transaction sets, further comprising:
a transmitting device configured to transmit at least the calculated member estimation score for each consumer transaction set and the set of consumer characteristics corresponding to the consumer identifier associated with each consumer transaction set.

16. The system of claim 14, wherein the target geographic area corresponds to a physical postal address of a business entity.

17. The system of claim 11, wherein the target geographic area corresponds to an area immediately surrounding a physical postal address of a business entity.

18. The system of claim 17, wherein calculating a member estimation score for each consumer transaction set includes assigning a weighted value to each transaction data entry of the consumer transaction set based on the geographic location of the point of sale identifier associated with each transaction data entry and the proximity of the geographic location of the point of sale identifier to the physical postal address of the business entity.

19. The system of claim 11, wherein calculating a member estimation score for each consumer transaction set takes into account at least one of: a frequency of payment transactions associated with the transaction data entries of the consumer transaction set, a recency of payment transactions associated with the transaction data entries of the consumer transaction set, and an industry type of payment transaction associated with the transaction data entries of the consumer transaction set.

20. The system of claim 18, wherein calculating a member estimation score for each consumer transaction set takes into account at least one of: a frequency of payment transactions associated with the transaction data entries of the consumer transaction set, a recency of payment transactions associated with the transaction data entries of the consumer transaction set, and an industry type of payment transaction associated with the transaction data entries of the consumer transaction set.
